(19) United States
(12) Patent Application Publication
(10) Pub. No.: US 2012/0155708 A1
(43) Pub. Date: Jun. 21, 2012

(54) APPARATUS AND METHOD FOR MEASURING TARGET POINT IN VIDEO

(75) Inventor: Hyung Seok LEE, Daejeon (KR)

(73) Assignee: ELECTRONICS AND TELECOMMUNICATIONS RESEARCH INSTITUTE, Daejeon (KR)

(21) Appl. No.: 13/329,804

(22) Filed: Dec. 19, 2011

(30) Foreign Application Priority Data
Dec. 20, 2010 (KR) 10-2010-0131055

(51) Int. Cl. G06K 9/00

(52) U.S. Cl. 382/103

(57) ABSTRACT

Disclosed are an apparatus and method for measuring a target point in a video. In the apparatus and method for measuring a target point in a video, a target point is recognized in a video including the target point set as a measuring target, information regarding the target point is extracted by using location information of the recognized target point and map information of the surroundings of the recognized target point, and the extracted target point is displayed in the video while providing detailed map information regarding the target point. Accordingly, a user can be quickly provided with detailed information regarding the location of the target point or an object present in a visual range and geo-spatial information of the surroundings.

### CROSS-REFERENCE TO RELATED APPLICATIONS

This application is based on and claims priority from Korean Patent Application No. 10-2010-0131055, filed on Dec. 20, 2010, with the Korean Intellectual Property Office, the disclosure of which is incorporated herein in its entirety by reference.

### TECHNICAL FIELD

The present disclosure relates to an apparatus and method for measuring a target point in a video, and more particularly, to an apparatus and method for measuring a video, capable of recognizing a target point in a video including the target point set as a measuring target, extracting information regarding the target point by using location information and map information of the surroundings of the recognized target point, and displaying the extracted target point in the video while providing detailed map information regarding the target point, thus quickly providing a user with detailed information regarding the location of the target point or an object present in a visual range and geospatial information about the surroundings thereof.

### BACKGROUND

Recently, various services and additional functions usable in a user terminal have been gradually expanded. The user terminal is being equipped with diverse service modules providing a variety of information to a user. To this end, techniques for measuring a location of a mobile terminal are in development, and thus the size of industry associated with services that provide measured location information of the mobile terminal is being continuously expanded.

Such a location measuring scheme is applicable to any mobile terminal that is capable of wireless data reception/transmission. For example, there are multiple wireless terminals such as personal mobile communication terminals, and navigators carried by pedestrians or mounted on vehicles. Examples of location measuring schemes for the wireless terminals may include a variety of measuring schemes including location measuring schemes based on a base station, and location measuring schemes using a global positioning system (GPS).

For example, when one user wants to learn his current location, a user terminal acquires cell information of a current location of the user terminal or GPS information through a position measuring module. The user terminal may provide the user with location information of the user terminal by using the acquired cell information or GPS information.

The various measuring schemes for measuring a location of a wireless terminal have various cons and pros. By way of example, in a case where a location detection service is provided for a mobile communication terminal without GPS equipment or for a mobile communication terminal located in an indoor space where GPS positioning is unavailable, location information is provided depending on information regarding a base station to which the mobile communication terminal belongs, which is stored in a subscriber visitor location register (VLS).

As one of the techniques for providing location information, a service that provides not only location information of a mobile terminal but also useful information at the current location is being increasingly used. For example, in the field of augmented reality, a user's location is detected by using a GPS or a GYRO sensor, and information regarding useful spots at the current location may be displayed on a screen. This augmented reality technique is a technique that matches additional information with a real image and provides the matched image to a user.

Meanwhile, a user of a mobile terminal may be provided with points of interest such as coupons, phone numbers or the like of a target point or object of interest, which is located in a visual range; however, location information such as a distance to the target point or an object of interest may not be accurately provided.

### SUMMARY

The present disclosure has been made in an effort to provide an apparatus and method for measuring a video, capable of recognizing a target point in a video including the target point set as a measuring target, extracting information regarding the target point by using location information of the recognized target point and map information of the surroundings of the target point, and displaying the extracted target point in the video while providing detailed map information regarding the target point, thus quickly providing a user with detailed information regarding the location of the target point or an object present in a visual range and regarding the surroundings thereof.

An exemplary embodiment of the present disclosure provides an apparatus for measuring a target point in a video, including: a location checking unit checking location information of a user terminal and acquiring map information of surroundings adjacent to the checked location information; a video capturing unit capturing a video including a target point set as a measuring target by a user; a target-point recognition unit recognizing the set target point from the captured video; a target-point information analysis unit analyzing a relationship between the recognized target point and the user terminal by using the acquired location information of the user terminal and the map information of the surroundings, and extracting target-point information; and a display unit displaying the captured video while displaying the extracted target-point information in the video being displayed.

Another exemplary embodiment of the present disclosure provides a method for measuring a target point in a video, including: a location checking operation in which location information of a user terminal is checked, and map information of surroundings adjacent to the checked location information is acquired; a video capturing operation in which a video including a target point set as a measuring target by a user is captured; a target-point recognizing operation in which the set target point is recognized from the captured video; a target-point information analyzing operation in which a relationship between the recognized target point and the user terminal is analyzed by using the acquired location information of the user terminal and the map information of the surroundings to extract target-point information; and a displaying operation in which the captured video is displayed while the extracted target-point information is displayed in the video being displayed.

According to the exemplary embodiments of the present disclosure, a target point is recognized from a video including the target point set as a measuring target, information regarding the target point is extracted by using location information of the recognized target point and map information of the surroundings of the target point and is displayed in the video while detailed map information thereof is also provided, thus quickly providing a user with detailed information regarding a location of the target point or an object within a visual range and regarding the surroundings thereof.

For example, the exemplary embodiments according to the present disclosure may be useful in golfing or hiking and may also be utilized in various fields.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an apparatus for measuring a target point in a video according to an exemplary embodiment of the present disclosure.

FIG. 2 is a flowchart of a method for measuring a target point in a video according to an exemplary embodiment of the present disclosure.

### DETAILED DESCRIPTION

In the following detailed description, reference is made to the accompanying drawing, which form a part hereof. The constitution and effect will be clearly understood through the following detailed description. In the drawings, like reference numerals refer to like elements throughout. Moreover, detailed descriptions related to well-known functions or configurations will be ruled out in order not to unnecessarily obscure subject matters presented here.

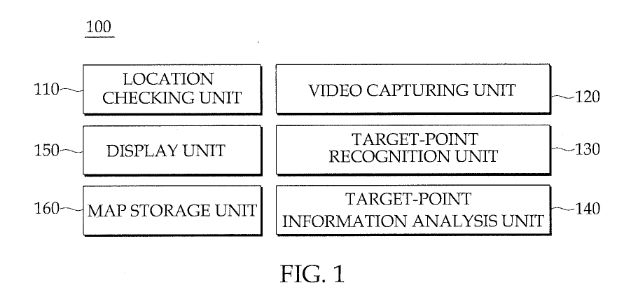

FIG. 1 is a block diagram illustrating an apparatus for measuring a target point in a video according to an exemplary embodiment of the present disclosure.

As shown in FIG. 1, an apparatus 100 for measuring a target point includes a location checking unit 110, a video capturing unit 120, a target-point recognition unit 130, a target-point information analysis unit 140, a display unit 15, and a map storage unit 160.

Apparatus 100 for measuring a target point according to the exemplary embodiment of the present disclosure is devised to quickly provide detailed information about a current location of a target point or an object currently located in a visual range, and detailed geospatial information of the surroundings in a video being displayed on display unit 150. That is, apparatus 100 for measuring a target point combines a video, input through video capturing unit 120, with current location information obtained using location checking unit 110 and pre-stored map information of the location. In such a manner, target-point information regarding the target point in a specific spot in a video can be extracted.

In detail, location checking unit 110 checks location information of a user terminal, and acquires map information of the surroundings from the checked location information. Location checking unit 110 may check the location information of the user terminal by using at least one of a global positioning system (GPS), a gravity sensor, a geo-magnetic sensor, and a gyro sensor. Location checking unit 110 may check location information including the location information of the user terminal and at least one of the latitude, the longitude, and the altitude thereof. For example, location checking unit 110 may be equipped with various sensors capable of detecting locations and motions, and may check a direction that a lens of a camera provided on display unit 150 faces by using those sensors. Location checking unit 110 may check the direction of a video being displayed through display unit 150 by detecting the direction in which the camera moves.

Video capturing unit 120 acquires a video by capturing a video including a target point set as a measuring target by a user.

Target-point recognition unit 130 may recognize the target point set by the user from the video captured by video capturing unit 120. When there is a request from a user to set multiple target points, target-point recognition unit 130 may designate one target point through the video and set another target point in another direction by moving the video of the user terminal. For example, in a case where a user wants to obtain location information and detailed geospatial information regarding a specific spot or object existing in the current visual range and being displayed through display unit 150, a target point may be selected by quickly designating a desired location from a video, being input in real time through a camera and displayed on a screen, by using a method such as touching or the like. Target-point recognition unit 130 may recognize the target point, designated by the user, through video processing.

Target-point information analysis unit 140 extracts information regarding the target point by analyzing the relationship between the user terminal and the target point recognized from target-point recognition unit 130 by using the location information of the user terminal and the map information of the surroundings, checked by location checking unit 110. Target-point information analysis unit 140 receives detailed geospatial information of the surroundings when there is a request from the user. Target-point information analysis unit 140 may learn detailed geospatial information regarding the target point, for example, a location of the target point (latitude, longitude, and altitude), relative location information from the current location (distance and altitude difference), and detailed topology of the surroundings, by using map information of the location stored in advance in a map server or the map storage unit 160. Target-point information analysis unit 140 may be combined with a path guidance algorithm to thus extract information regarding a distance of a road or a trail, as well as a linear distance.

While displaying a video captured by video capturing unit 120, display unit 150 may display in the video the target-point information extracted by target-point information analysis unit 140. The user selects a target point located in the user's visual range in the video being displayed through display unit 150. Display unit 150 may display detailed geospatial information regarding the surroundings of the target point in the video or in another video. Display unit 150 may display the detailed geospatial information regarding the surroundings of the recognized target point in a way that simultaneously supports both zooming and view-point switching. Display unit 150 may display in the video road or trail path information extracted by target-point information analysis unit 140.

Meanwhile, map storage unit 160 stores map information of the surroundings adjacent to the location information checked by location checking unit 110, and stores detailed geospatial information. Here, map storage unit 160 may be stored in an external server.

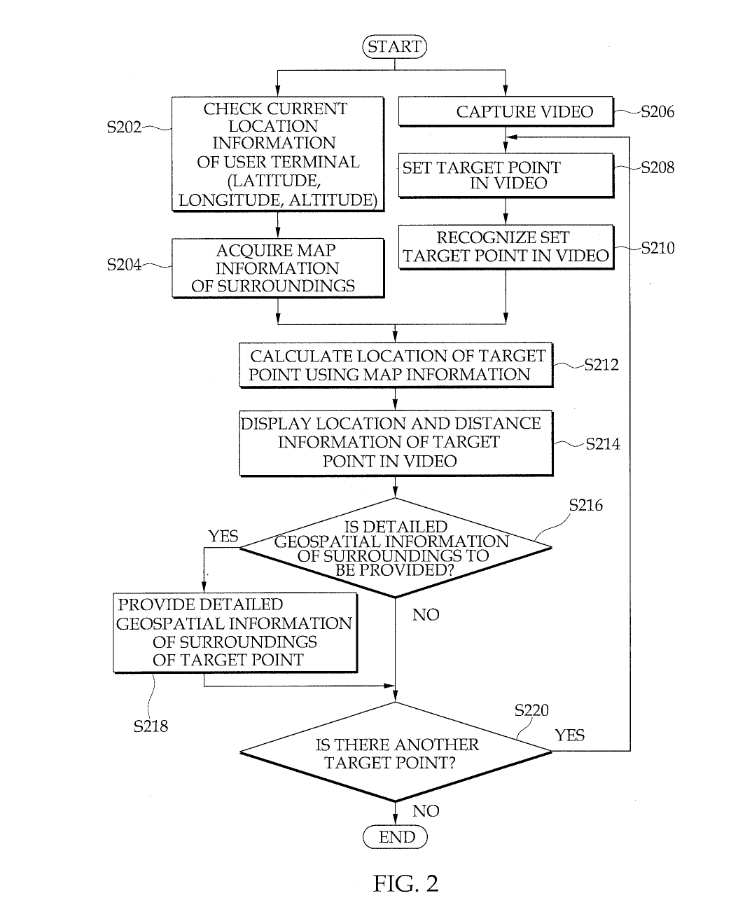

FIG. 2 is a flowchart of a method for measuring a target point in a video according to an exemplary embodiment of the present disclosure.

Location checking unit 110 checks current location information of a user terminal in operation S202. Location checking unit 110 may recognize the current location information by using at least one of a GPS, a gravity sensor, a geomagnetic sensor, and a gyro sensor.

Location checking unit 110 acquires map information of the surroundings in operation S204. To this end, location checking unit 110 may load map information of the surroundings based on the current location information from the map storage unit 160 or a map server.

Video capturing unit 120 captures a video including a target point set by a user and acquires the video in operation S206. That is, when the user makes a camera of the user terminal face toward the target point to obtain information regarding the target point, video capturing unit 120 captures a video such that the target point is displayed on the screen of display unit 150, and transmits the video to display unit 150.

When the user selects the target point from the video, target-point recognition unit 130 recognizes the target point corresponding to the user's selection in operation S210. When the corresponding target point is designated by a touch method or the like from the video displayed on the screen through a camera lens by the user, target-point recognition unit 130 may recognize the target point corresponding to the user's selection through video processing. For example, target-point recognition unit 130 may recognize the corresponding target point by recognizing a shape of the target point included in the surrounding map information.

Thereafter, in operation S212, target-point information analysis unit 140 calculates a location of the recognized target point by using the location information and surrounding map information acquired in the operations S202 and S204. Target-point information analysis unit 140 may analyze target-point information regarding the recognized target point. The target-point information may include information about the latitude, longitude, and altitude of the target point, and relative location information from the location of the user, namely, information about distance and altitude difference.

In operation 5214, display unit 150 displays in the video the location and distance information about the target point analyzed by target-point information analysis unit 140, namely, the target-point information.

Thereafter, target-point information analysis unit 140 checks whether or not there is a request for detailed map information of the surroundings from the user in operation S216. This is to provide a function to investigate detailed geospatial features of the surroundings of the target point upon the user's request.

If there is a request for detailed map information of the surroundings in operation S216, target-point analysis unit 140 extracts detailed geospatial information of the surroundings of the target point from the map information of the surroundings acquired in operation S204, and provides the extracted information to the user through the display unit 150. In this case, target-point information analysis unit 140, if required, may be provided with additional detailed map information regarding the surroundings of the target point from a map server via a communication network. In this case, display unit 150 may simultaneously support both zooming and view-point switching for detailed investigation on the surroundings of the target point.

However, if there is no request for the detailed map information of the surroundings in operation S216, target-point information analysis unit 140 performs the process from operation S220.

In operation S220, target point recognition unit 130 monitors whether or not there is another target point. Here, the user may set multiple target points. For example, a user may designate one target point through a screen and then rotate a mounted camera to thus designate other target points in different directions. In this case, target-point recognition unit 130 may recognize different target points. Display unit 150 may display in the video current locations and relative location information between the target points according to the result of the analysis of target-point information analysis unit 140.

When there is another target point in operation S220, target point recognition unit 130 performs the process from the operation S208 in which the target point is set in the video. However, when there is no other target point, the target-point measuring process is terminated.

The apparatus and method for measuring a target point described in the above disclosure may be implemented into a software program and be recorded on a predetermined computer-readable recording medium to thus be utilized by various reproduction devices.

The various reproduction devices are user terminals described above and may include mobile terminals, personal digital assistances (PDA), notebook computers, navigators, portable multimedia players (PMP), smart phones, electronic dictionaries, MPS and the like.

Examples of the computer readable recording medium may include hard disks, flash memories, random access memories (RAM), read-only memories (ROM), and the like as built-in recording medium, and as an external type, may include optical disks such as CD-R and CD-RW, compact flash cards, memory sticks, multimedia cards, and the like.

In this case, the program recorded on the computer readable medium may execute a video capturing and displaying process of capturing a video including a target point set as a measuring target by a user and displaying the captured video, a location checking process of checking location information of a user terminal and acquiring map information regarding the surroundings from the checked location information, a target-point recognizing process of recognizing the set target point from the captured video, a target-point information analyzing process of analyzing the relationship between the recognized target point and the user terminal by using the acquired location information of the user terminal and the map information of the surroundings, and thus extracting target-point information, and a displaying process of displaying the extracted target-point information in the video being displayed.

According to the exemplary embodiments of the present disclosure, a target point in a video including the target point set as a measuring target is recognized, information regarding the target point is extracted by using location information of the target point and map information of the surroundings with regard to the recognized target point, and the extracted information is displayed in the video while detailed map information thereof is also provided therein. In such a manner, the user can be quickly provided with detailed information regarding the location or surrounding geospatial features of the target point or object located in a user's visual range. In this regard, since the apparatus and method for measuring a target point in a video disclosed in the present disclosure overcome the limitations of existing technique, they are considered to have industrial applicability.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for measuring a target point in a video, comprising:
a location checking unit checking location information of a user terminal and acquiring map information of surroundings adjacent to the checked location information;
a video capturing unit capturing a video including a target point set as a measuring target by a user;
a target-point recognition unit recognizing the set target point from the captured video;
a target-point information analysis unit analyzing a relationship between the recognized target point and the user terminal by using the acquired location information of the user terminal and the map information of the surroundings, and extracting target-point information; and
a display unit displaying the captured video while displaying the extracted target-point information in the video being displayed.

2. The apparatus of claim 1, further comprising a map storage unit storing map information of the surroundings adjacent to the checked location information, the map storage unit storing detailed geospatial information.

3. The apparatus of claim 1, wherein the location checking unit checks the location information of the user terminal by using at least one of a global positioning system (GPS) sensor, a gravity sensor, a geomagnetic sensor, and a gyro sensor.

4. The apparatus of claim 1, wherein the location information of the user terminal, checked by the location checking unit, includes at least one of latitude, longitude, and altitude.

5. The apparatus of claim 1, wherein when there is a request for detailed geospatial information of the surroundings from the user, the target-point information analysis unit receives detailed geospatial information of the surroundings of the recognized target point, and the display unit displays the received detailed geospatial information of the surroundings of the target point in the video or in another screen.

6. The apparatus of claim 1, wherein the display unit displays detailed geospatial information of the surroundings of the recognized target point by simultaneously supporting both zooming and view-point switching.

7. The apparatus of claim 1, wherein when there is request for setting multiple target points from the user, the target-point recognition unit designates one target point through a screen, and moves the screen of the user terminal to set another target point in another direction.

8. A method for measuring a target point in a video, the method comprising:
a location checking operation in which location information of a user terminal is checked, and map information of surroundings adjacent to the checked location information is acquired;
a video capturing operation in which a video including a target point set as a measuring target by a user is captured;
a target-point recognizing operation in which the set target point is recognized from the captured video;
a target-point information analyzing operation in which a relationship between the recognized target point and the user terminal is analyzed by using the acquired location information of the user terminal and the map information of the surroundings to extract target-point information; and
a displaying operation in which the captured video is displayed together with the extracted target-point information, in the video being displayed.

9. The method of claim 8, wherein in the location checking operation, the location information of the user terminal is checked by using at least one of a global positioning system (GPS) sensor, a gravity sensor, a geomagnetic sensor, and a gyro sensor.

10. The method of claim 8, wherein in the location checking operation, the location information of the user terminal includes at least one of latitude, longitude and altitude.

11. The method of claim 8, wherein when there is a request for detailed geospatial information of the surroundings from the user, in the target-point information analyzing operation, detailed geospatial information of the surroundings of the recognized target point is received, and
in the displaying operation, the received detailed geospatial information of the surroundings of the target point is displayed in the video or in another screen.

12. The method of claim 8, wherein in the target-point recognizing operation, when there is a request for setting multiple target points from the user, one target point is designated through a screen and the screen of the user terminal is then moved to set another target point in another direction.

13. The method of claim 8, wherein in the displaying operation, detailed geospatial information of the surroundings of the recognized target point is displayed by simultaneously supporting both zooming and view-point switching.
